(19) United States
(12) Patent Application Publication
(10) Pub. No.: US 2012/0106171 A1
(43) Pub. Date: May 3, 2012

(54) LED PACKAGE STRUCTURE

(75) Inventors: BILY WANG, HSINCHU CITY (TW); SUNG-YI HSIAO, MIAOLI COUNTY (TW); YU-JEN CHENG, TAINAN CITY (TW); JACK CHEN, MIAOLI COUNTY (TW)

(73) Assignee: HARVATEK CORPORATION, HSINCHU CITY (TW)

(21) Appl. No.: 13/176,799

(22) Filed: Jul. 6, 2011

(30) Foreign Application Priority Data
Nov. 3, 2010 (TW) 99221285

(51) Int. Cl. F21V 15/00

(52) U.S. Cl. 362/362

(57) ABSTRACT

An LED package structure includes a conductive substrate unit, a first insulative unit, a second insulative unit, a light-emitting unit and a package unit. The conductive substrate unit includes at least two conductive bases and at least one gap is formed between the two conductive bases. The first insulative unit includes at least one first insulative layer filled in the gap to join the two conductive bases. The second insulative unit includes at least one second insulative layer disposed on the conductive substrate unit and a plurality of openings passing through the second insulative layer for exposing one part of the top surface of each conductive base. The light-emitting unit includes at least one light-emitting element passing one of the openings and electrically connected between the two conductive bases. The package unit includes a package resin body disposed on the second insulative unit to cover the light-emitting element.

### BACKGROUND OF THE INVENTION

1. Field of the Invention

The instant disclosure relates to an LED package structure, and more particularly, to an LED package structure for increasing heat-dissipating efficiency.

2. Description of Related Art

Light-Emitting Diodes (LED) are widely used in electronic devices or on lamp illumination. Generally, the package substrate of a high power LED is applied as a ceramic substrate. Though, the technique of the manufacture of the ceramic substrate is high, the fragile characteristic and great expense restricts the LED package design. Due to the advantage of low expense of silicon wafer, the manufacturing technology has reached maturity for designing structures in the wafer, and the thermal conductivity of silicon is also close to the ceramic material, though the manufacturing cost of silicon substrate is higher than the manufacturing cost of ceramic substrate, it is not possible to save costs for applying a silicon substrate without any adverse effects of the thermal conduction reduction.

As in the LED structure of the surface attaching type in prior art, the installed section of the LED chip is defined by the package base of an aperture rendering the light radiate. During the LED chip operation, some light beaming toward the base sidewall is absorbed or lost through reflecting or scattering, and there is only a small amount of light that can project out through the aperture. Thus the output efficiency is reduced for the absorption of the light causing the power loss. And the accompanying heat accumulation of the LED operation is another disadvantage against the luminous efficiency.

Referring to FIG. 1, the related art provides an LED package structure includes at least two conductive substrates 10a, an insulative frame 20a having a reflecting groove for join the two conductive substrates 10a together, an LED chip 30a disposed on one of the two conductive substrates 10a and electrically connected between the two conductive substrates 10a, and a package resin body 40a filled into the reflecting groove to cover the LED chip 30a.

### SUMMARY OF THE INVENTION

One particular aspect of the instant disclosure is to provide an LED package structure for increasing heat-dissipating efficiency.

One embodiment of the instant disclosure provides an LED package structure, comprising: a conductive substrate unit, a first insulative unit, a second insulative unit, a light-emitting unit and a package unit. The conductive substrate unit includes at least two conductive bases separated from each other by a predetermined distance, wherein at least one gap is formed between the at least two conductive bases. The first insulative unit includes at least one first insulative layer filled in the gap to join the at least two conductive bases. The second insulative unit includes at least one second insulative layer disposed on the conductive substrate unit, wherein the least one second insulative layer has a plurality of openings passing therethrough for exposing one part of the top surface of each conductive base. The light-emitting unit includes at least one light-emitting element passing one of the openings and disposed on one of the conductive bases, wherein the at least one light-emitting element is electrically connected between the at least two conductive bases. The package unit includes at least one package resin body disposed on the second insulative unit to cover the at least one light-emitting element.

For example, one of the at least two conductive bases has a bottom concave portion formed on the bottom side thereof to communicate with the gap, and the at least one first insulative layer is filled in the bottom concave portion. Each conductive base has a bottom concave portion formed on the bottom side thereof to communicate with the gap, and the at least one first insulative layer is filled in the bottom concave portion of each conductive base. One of the at least two conductive bases has a lateral concave portion formed on the lateral side thereof to communicate with the gap, and the at least one first insulative layer is filled in the lateral concave portion. Each conductive base has a lateral concave portion formed on the lateral side thereof to communicate with the gap, and the at least one first insulative layer is filled in the lateral concave portion of each conductive base. The top surface and the bottom surface of the at least one first insulative layer are respectively flushed with the top surface and the bottom surface of each conductive base. One of the conductive bases includes a plurality of position grooves disposed on the top surface thereof to surround the at least one light-emitting element. The position grooves and the at least one light-emitting element are exposed by the same opening. The at least one package resin body includes a bottom resin portion disposed on the second insulative unit and a lens resin portion disposed above the at least one light-emitting element and integrally formed with the bottom resin portion.

Another embodiment of the instant disclosure provides an LED package structure, comprising: a conductive substrate unit, a first insulative unit, a second insulative unit, a light-emitting unit and a package unit. The conductive substrate unit including at least two conductive bases separated from each other by a predetermined distance and at least one heat-dissipating base disposed between the at least two conductive bases and separated from the at least two conductive bases by a predetermined distance, wherein at least two gaps are respectively formed between one of the at least two conductive bases and the heat-dissipating base and between the other conductive base and the heat-dissipating base. The first insulative unit includes at least two first insulative layers respectively filled in the two gaps to join the heat-dissipating base with the at least two conductive bases. The second insulative unit includes at least one second insulative layer disposed on the conductive substrate unit, wherein the least one second insulative layer has a plurality of openings passing therethrough for exposing one part of the top surface of each conductive base and one part of the top surface of the heat-dissipating base. The light-emitting unit includes at least one light-emitting element passing one of the openings and disposed on the heat-dissipating base, wherein the at least one light-emitting element is electrically connected between the at least two conductive bases. The package unit includes at least one package resin body disposed on the second insulative unit to cover the at least one light-emitting element.

For example, each conductive base has a bottom concave portion formed on the bottom side thereof to communicate with each gap, and each first insulative layer is filled in the bottom concave portion of each conductive base. Each conductive base has a lateral concave portion formed on the lateral side thereof to communicate with each gap, and each first insulative layer is filled in the lateral concave portion of each conductive base. The heat-dissipating base has two bottom concave portions formed on the bottom side thereof to respectively communicate with the two gaps, and each first insulative layer is filled in each bottom concave portion of the heat-dissipating base. The top surface of the at least one first insulative layer, the top surface of each conductive base and the top surface of the heat-dissipating base are coplanar, and the bottom surface of the at least one first insulative layer, the bottom surface of each conductive base and the bottom surface of the heat-dissipating base are coplanar. The heat-dissipating base includes a plurality of position grooves disposed on the top surface thereof to surround the at least one light-emitting element. The position grooves and the at least one light-emitting element are exposed by the same opening. The at least one light-emitting element is an LED chip. The at least one package resin body includes a bottom resin portion disposed on the second insulative unit and a lens resin portion disposed above the at least one light-emitting element and integrally formed with the bottom resin portion.

Therefore, the at least two conductive bases can be jointed with each other through the at least one first insulative layer formed between the at least two conductive bases, and the at least one light-emitting element can be positioned on one of the at least two conductive bases to increase heat-dissipating efficiency.

To further understand the techniques, means and effects the instant disclosure takes for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention that they be used for limiting the instant disclosure.

### BRIEF DESCRIPTION OF THE DRAWINGS

FIG. 1 shows a cross-sectional, schematic view of the LED package structure according to the related art;

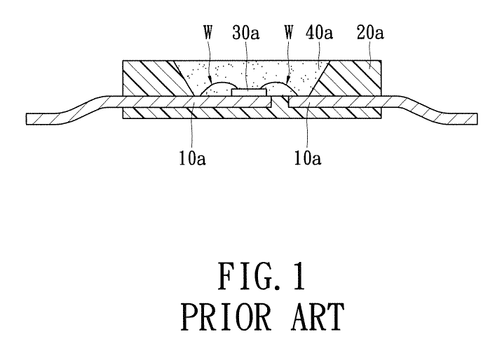

FIGS. 2A to 2F show cross-sectional, schematic views of the LED package structure according to the first embodiment of the instant disclosure, at different stages of the making processes, respectively;

FIG. 2G shows a cross-sectional, schematic view of the LED package structure according to the first embodiment of the instant disclosure;

FIG. 3 shows a cross-sectional, schematic view of the LED package structure according to the second embodiment of the instant disclosure;

FIG. 4A shows a perspective, exploded, schematic view of the LED package structure according to the third embodiment of the instant disclosure;

FIG. 4B shows another perspective, exploded, schematic view of the LED package structure according to the third embodiment of the instant disclosure;

FIG. 4C shows a bottom, schematic view of the at least two conductive bases of the LED package structure according to the third embodiment of the instant disclosure;

FIG. 4D shows a perspective, assembled, schematic view of the LED package structure according to the third embodiment of the instant disclosure;

FIG. 4E shows another perspective, assembled, schematic view of the LED package structure according to the third embodiment of the instant disclosure; and

FIG. 5 shows a cross-sectional, schematic view of the LED package structure according to the fourth embodiment of the instant disclosure.

### DETAILED DESCRIPTION OF THE PREFERRED EMBODIMENTS

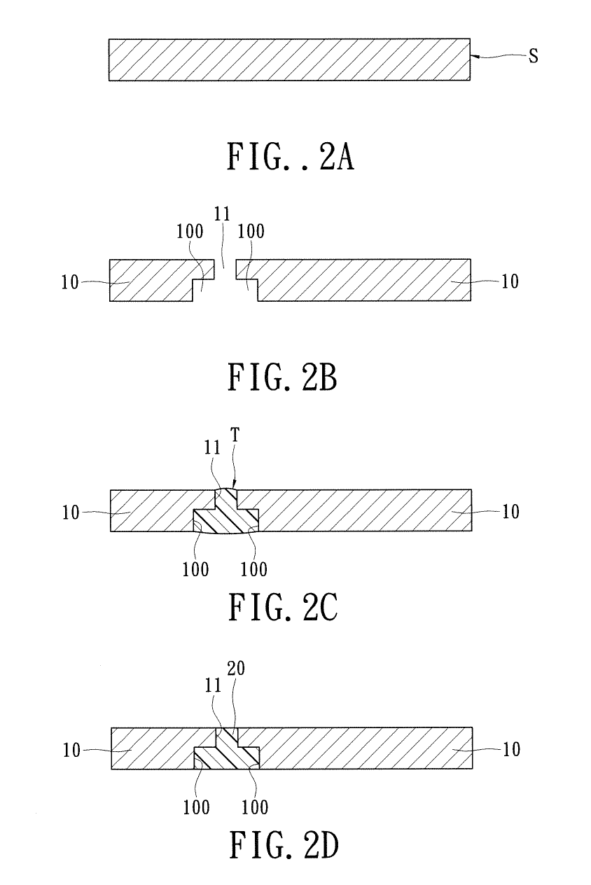

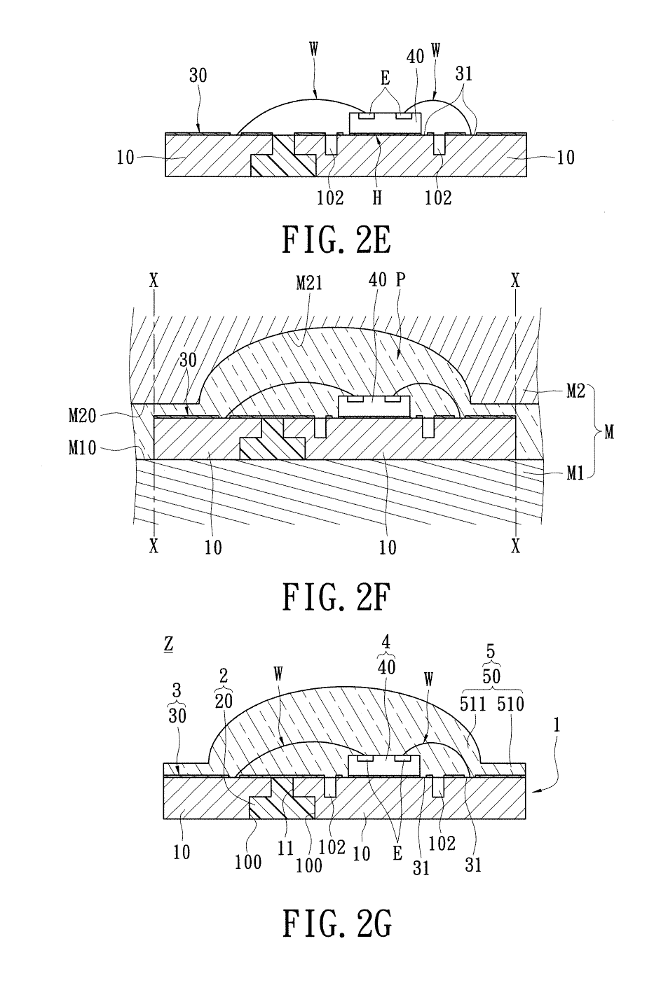

Referring to FIGS. 2A to 2G, the first embodiment of the instant disclosure provides a method for making an LED package structure, comprising the following steps:

The step S100 is that: referring to FIG. 2A, providing a conductive substrate S that can be made of metal material such as copper having an electrical and heat conducting function.

The step S102 is that: referring to FIGS. 2A and 2B, removing one part of the conductive substrate S to form at least two conductive bases 10 separated from each other by a predetermined distance, wherein at least one gap 11 is formed between the at least two conductive bases 10. One part of the conductive substrate S may be removed by etching or other removing methods, and the at least two conductive bases 10 are conductive elements. Each conductive base 10 has a bottom concave portion 100 formed on the bottom side thereof to communicate with the gap 11, thus the gap 11 and the two bottom concave portions 100 are communicated with each other to form a step-shaped receiving space.

The step S104 is that: referring to FIG. 2C, filling an insulative material T between the at least two conductive bases 10. In other words, the insulative material T is filled into the gap 11 and the two bottom concave portions 100, thus the at least two conductive bases 10 are firmly jointed with each other by the insulative material T.

The step S106 is that: referring to FIG. 2D, removing one part of the top portion and one part of the bottom portion of the insulative material T to form a first insulative layer 20 is filled in the gap 11 and the two bottom concave portions 100, thus the at least two conductive bases 10 are firmly jointed with each other by the at least one first insulative layer 20. In addition, the top surface of the at least one first insulative layer 20 and the top surface of each conductive base 10 are coplanar, and the bottom surface of the at least one first insulative layer 20 and the bottom surface of each conductive base 10 are coplanar. In other words, the top surface and the bottom surface of the at least one first insulative layer 20 are respectively flushed with the top surface and the bottom surface of each conductive base 10. Because the gap 11 and the two bottom concave portions 100 are communicated with each other to form the step-shaped receiving space, the at least one first insulative layer 20 can be firmly connected between the at least two conductive bases 10.

The step S108 is that: referring to FIG. 2E, forming a second insulative layer 30 such as solder mask on the top surfaces of the at least two conductive bases 10, and then positioning at least one light-emitting element 40 on one of the at least two conductive bases 10 by an adhesive layer H, wherein the at least one light-emitting element 40 is electrically connected between the at least two conductive bases 10. For example, the at least one light-emitting element 40 has two electrodes E on the top surface thereof, and the two electrodes E of the at least one light-emitting element 40 are electrically connected to the at least two conductive bases 10 through two lead wires W, respectively. In addition, the least one second insulative layer 30 has a plurality of openings 31, thus the at least one light-emitting element 40 and the two lead wires W can pass through the openings 31 to contact the at least two conductive bases 10. One of the conductive bases 10 includes a plurality of position grooves 102 disposed on the top surface thereof to surround the at least one light-emitting element 40 for judging whether the position of the at least one light-emitting element 40 is correct. In other words, when the at least one light-emitting element 40 is surrounded by the position grooves 102, the at least one light-emitting element 40 is positioned at a correct region.

The step S110 is that: referring to FIG. 2F, providing a mold unit M including a bottom mold M1 and a top mold M2 above the bottom mold M1. The bottom mold M1 has a top plane surface M10 formed on the top surface thereof, and the top mold M2 has a bottom plane surface M20 formed on the bottom surface thereof and a concave space M21 concaved inwardly from the bottom plane surface M20. When the at least two conductive bases 10 are placed on the top plane surface M10 of the bottom mold M1, the top mold M2 is disposed above the at least two conductive bases 10 and the at least one light-emitting element 40 corresponds to the concave space M21, thus a type of package material P can be filled between the top mold M2 and the bottom mold M1.

The step S112 is that: referring to FIGS. 2F and 2G, cutting the package material P along the X-X line in FIG. 2F to form a package resin body 50 as shown in FIG. 2G. The at least one package resin body 50 includes a bottom resin portion 510 disposed on the second insulative unit 3 and a lens resin portion 511 disposed above the at least one light-emitting element 40 and integrally formed with the bottom resin portion 510. Hence, the at least one package resin body 50 can be formed on the least one second insulative layer 30 to cover the at least one light-emitting element 40 as shown in FIG. 2G.

In conclusion, referring to FIG. 2G, the first embodiment of the instant disclosure provides LED package structure Z, comprising: a conductive substrate unit 1, a first insulative unit 2, a second insulative unit 3, a light-emitting unit 4 and a package unit 5.

The conductive substrate unit 1 includes at least two conductive bases 10 separated from each other by a predetermined distance, and at least one gap 11 formed between the at least two conductive bases 10. Each conductive base 10 has a bottom concave portion 100 formed on the bottom side thereof to communicate with the gap 11, and one of the conductive bases 10 includes a plurality of position grooves 102 disposed on the top surface thereof to surround the at least one light-emitting element 40 for judging whether the position of the at least one light-emitting element 40 is correct or not.

The first insulative unit 2 includes at least one first insulative layer 20 filled in the gap 11 and the bottom concave portion 100 to join the at least two conductive bases 10 together. The top surface and the bottom surface of the at least one first insulative layer 20 are respectively flushed with the top surface and the bottom surface of each conductive base 10.

The second insulative unit 3 includes at least one second insulative layer 30 disposed on the conductive substrate unit 1, and the least one second insulative layer 30 has a plurality of openings 31 passing therethrough for exposing one part of the top surface of each conductive base 10.

The light-emitting unit 4 includes at least one light-emitting element 40 passing one of the openings 31 and disposed on one of the conductive bases 10, and the at least one light-emitting element 40 is electrically connected between the at least two conductive bases 10. In other words, the at least one light-emitting element 40 has two electrodes E on the top surface thereof, and the two electrodes E of the at least one light-emitting element 40 are electrically connected to the at least two conductive bases 10 through two lead wires W, respectively.

The package unit 5 includes at least one package resin body 50 disposed on the second insulative unit 3 to cover the at least one light-emitting element 40, and the at least one package resin body 50 includes a bottom resin portion 510 disposed on the second insulative unit 3 and a lens resin portion 511 disposed above the at least one light-emitting element 40 and integrally formed with the bottom resin portion 510.

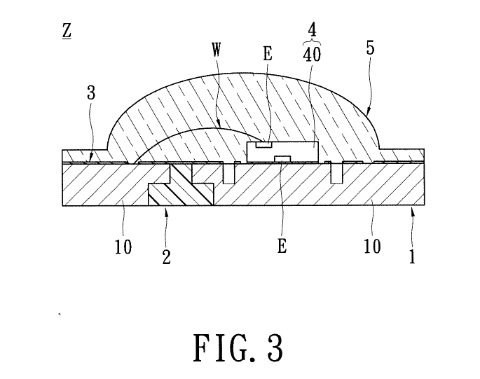

Referring to FIG. 3, the second embodiment of the instant disclosure provides LED package structure Z, comprising: a conductive substrate unit 1, a first insulative unit 2, a second insulative unit 3, a light-emitting unit 4 and a package unit 5. The difference between the second embodiment and the first embodiment is that: in the second embodiment, the at least one light-emitting element 40 has two electrodes E respectively disposed on the top surface and the bottom surface thereof. The bottom electrode E contacts one of the at least two conductive bases 10, and the top electrode E is electrically connected to the other conductive base 10 through a lead wire W.

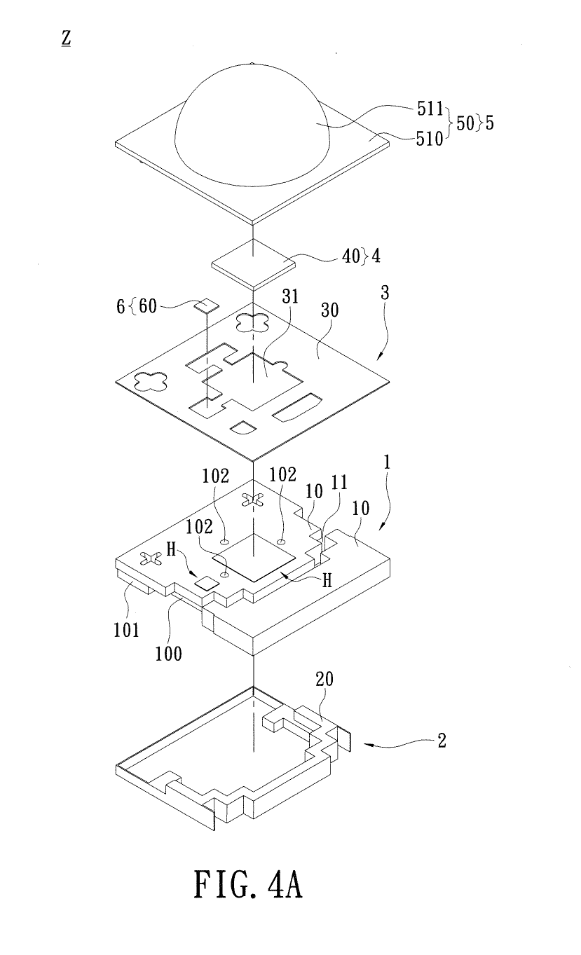

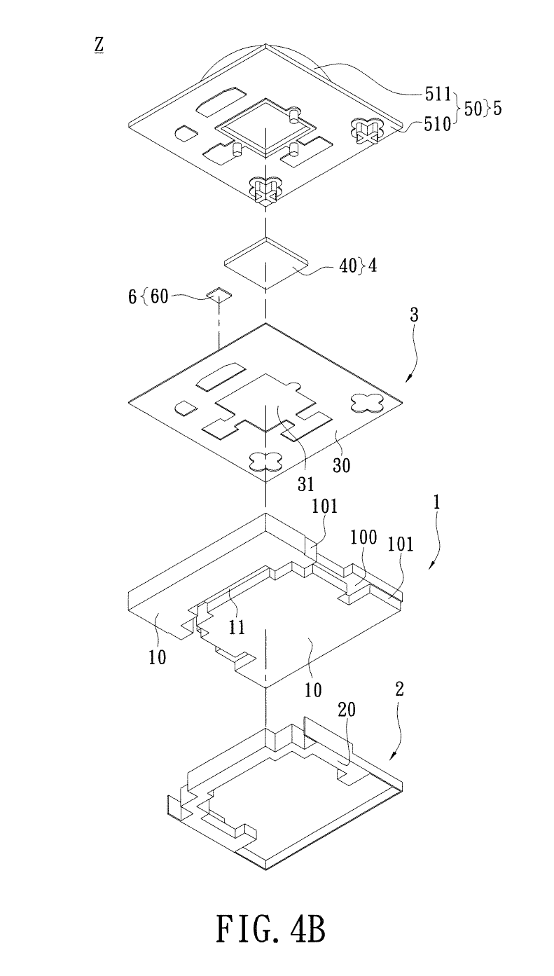

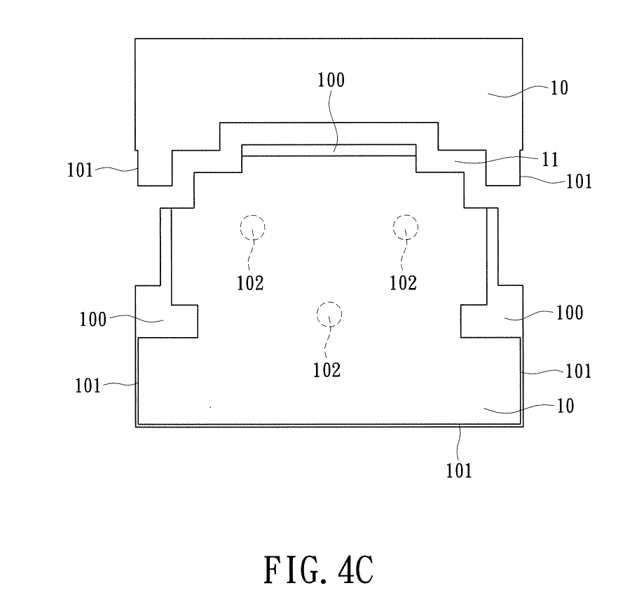

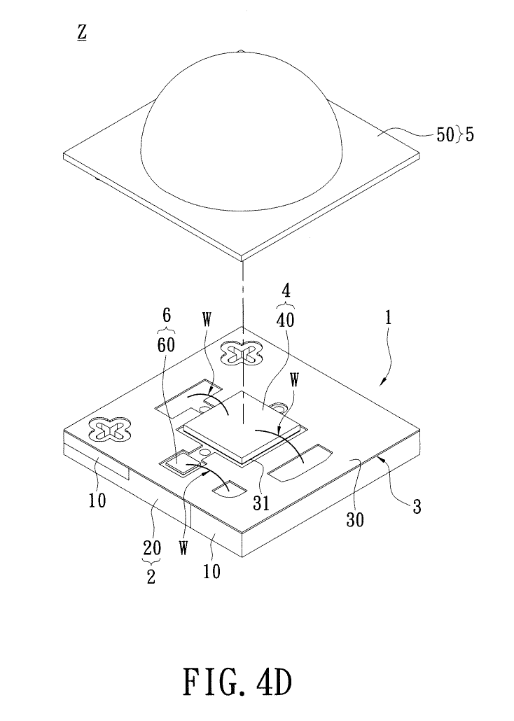

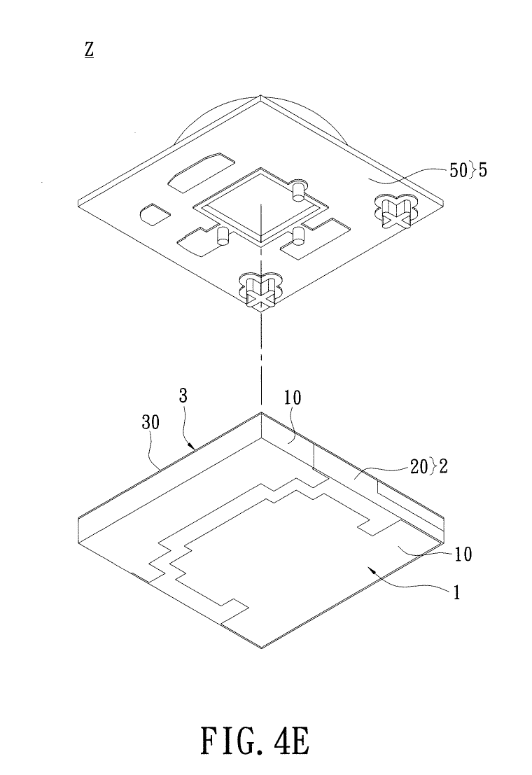

Referring to FIGS. 4A to 4E, the third embodiment of the instant disclosure provides LED package structure Z, comprising: a conductive substrate unit 1, a first insulative unit 2, a second insulative unit 3, a light-emitting unit 4 and a package unit 5.

The conductive substrate unit 1 includes at least two conductive bases 10 separated from each other by a predetermined distance and at least one gap 11 formed between the at least two conductive bases 10.

The first insulative unit 2 includes at least one first insulative layer 20 filled in the gap 11 to join the at least two conductive bases 10 together. For example, the top surface and the bottom surface of the at least one first insulative layer 20 are respectively flushed with the top surface and the bottom surface of each conductive base 10. In addition, one of the at least two conductive bases 10 (as shown in the third embodiment) or each conductive base 10 has a bottom concave portion 100 formed on the bottom side thereof to communicate with the gap 11, and the at least one first insulative layer 20 is filled in the bottom concave portion 100 of the conductive base 10 or each conductive base 10. Moreover, one of the at least two conductive bases 10 or each conductive base 10 (as shown in the third embodiment) has a lateral concave portion 101 formed on the lateral side thereof to communicate with the gap 11, and the at least one first insulative layer 20 is filled in the lateral concave portion 101 of the conductive base 10 or each conductive base 10.

The second insulative unit 3 includes at least one second insulative layer 30 disposed on the conductive substrate unit 1 and a plurality of openings 31 passing through the least one second insulative layer 30 for exposing one part of the top surface of each conductive base 10.

The light-emitting unit 4 includes at least one light-emitting element 40 passing one of the openings 31 and disposed on one of the conductive bases 10 by an adhesive layer H, and the at least one light-emitting element 40 is electrically connected between the at least two conductive bases 10. For example, one of the conductive bases 10 includes a plurality of position grooves 102 (such as three grooves 102) disposed on the top surface thereof to surround the at least one light-emitting element 40 for judging whether the position of the at least one light-emitting element 40 is correct. In other words, when the at least one light-emitting element 40 is surrounded by the position grooves 102, the at least one light-emitting element 40 is positioned at a correct region. The position grooves 102 and the at least one light-emitting element 40 are exposed by the same opening 31.

The package unit 5 includes at least one package resin body 50 disposed on the second insulative unit 3 to cover the at least one light-emitting element 40. For example, the at least one package resin body 50 includes a bottom resin portion 510 disposed on the second insulative unit 3 and a lens resin portion 511 disposed above the at least one light-emitting element 40 and integrally formed with the bottom resin portion 510.

The third embodiment further comprises a surge-proof unit 6 including at least one surge-proof element 60 (such as zener diode with anti-static function) passing through one of the openings 31 and disposed on one of the conductive bases 10. For example, the surge-proof element 60 can be positioned on one of the conductive bases 10 by an adhesive layer H, and the surge-proof element 60 can be electrically connected between the at least two conductive bases 10 by wire bonding. In other words, one electrode of the surge-proof element 60 contacts one of the at least two conductive bases 10 and another electrode of the surge-proof element 60 is electrically connected to the other conductive base 10 by a lead wire W.

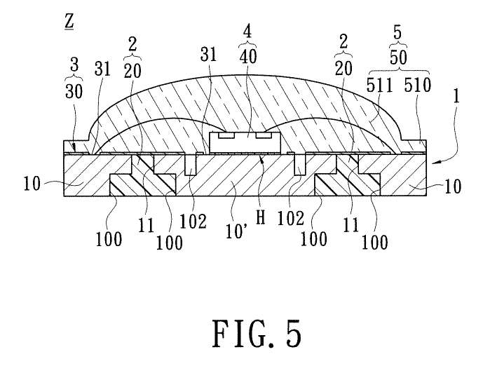

Referring to FIG. 5, the fourth embodiment of the instant disclosure provides LED package structure Z, comprising: a conductive substrate unit 1, a first insulative unit 2, a second insulative unit 3, a light-emitting unit 4 and a package unit 5.

The conductive substrate unit 1 includes at least two conductive bases 10 separated from each other by a predetermined distance, at least one heat-dissipating base 10′ disposed between the at least two conductive bases 10 and separated from the at least two conductive bases 10 by a predetermined distance, and at least two gaps 11 are respectively formed between one of the at least two conductive bases 10 and the heat-dissipating base 10′ and between the other conductive base 10 and the heat-dissipating base 10′. For example, each conductive base 10 has a bottom concave portion 100 formed on the bottom side thereof to communicate with each gap 11, each conductive base 10 may has a lateral concave portion (not shown, but the same as the third embodiment) formed on the lateral side thereof to communicate with each gap 11, and the heat-dissipating base 10′ has two bottom concave portions 100 formed on the bottom side thereof to respectively communicate with the two gaps 11.

The first insulative unit 2 includes at least two first insulative layers 20 respectively filled in the two gaps 11 to join the heat-dissipating base 10′ with the at least two conductive bases 10. For example, the top surface of the at least one first insulative layer 20, the top surface of each conductive base 10 and the top surface of the heat-dissipating base 10′ are coplanar or flushed with each other, and the bottom surface of the at least one first insulative layer 20, the bottom surface of each conductive base 10 and the bottom surface of the heat-dissipating base 10′ are coplanar or flushed with each other. In addition, each first insulative layer 20 can be filled in the bottom concave portion 100 and the lateral concave portion (not shown) of each conductive base 10 and each first insulative layer 20 also can be filled in each bottom concave portion 100 of the heat-dissipating base 10′.

The second insulative unit 3 includes at least one second insulative layer 30 disposed on the conductive substrate unit 1 and a plurality of openings 31 passing through the least one second insulative layer 30 for exposing one part of the top surface of each conductive base 10 and one part of the top surface of the heat-dissipating base 10′.

The light-emitting unit 4 includes at least one light-emitting element 40 passing one of the openings 31 and disposed on the heat-dissipating base 10′, and the at least one light-emitting element 40 is electrically connected between the at least two conductive bases 10. For example, the at least one light-emitting element 40 may be an LED chip (bare die), and the at least one light-emitting element 40 can be positioned on the heat-dissipating base 10′ by an adhesive layer H. The heat-dissipating base 10′ includes a plurality of position grooves 102 disposed on the top surface thereof to surround the at least one light-emitting element 40 for judging whether the position of the at least one light-emitting element 40 is correct. In other words, when the at least one light-emitting element 40 is surrounded by the position grooves 102, the at least one light-emitting element 40 is positioned at a correct region. The position grooves 102 and the at least one light-emitting element 40 are exposed by the same opening 31.

The package unit 5 includes at least one package resin body 50 disposed on the second insulative unit 3 to cover the at least one light-emitting element 40. For example, the at least one package resin body 50 includes a bottom resin portion 510 disposed on the second insulative unit 3 and a lens resin portion 511 disposed above the at least one light-emitting element 40 and integrally formed with the bottom resin portion 510.

The fourth embodiment further comprises a surge-proof unit (not shown, but the function is the same as the third embodiment) including at least one surge-proof element (not shown) passing through one of the openings 31 and disposed on the heat-dissipating base 10′. For example, the surge-proof element can be positioned on the heat-dissipating base 10′ by an adhesive layer H, and the surge-proof element can be electrically connected between the at least two conductive bases 10 by wire bonding.

In conclusion, one embodiment of the instant disclosure provides an LED package structure, comprising: a conductive substrate unit, a first insulative unit, a second insulative unit, a light-emitting unit and a package unit. The conductive substrate unit includes at least two conductive bases separated from each other by a predetermined distance, wherein at least one gap is formed between the at least two conductive bases. The first insulative unit includes at least one first insulative layer filled in the gap to join the at least two conductive bases. The second insulative unit includes at least one second insulative layer disposed on the conductive substrate unit, wherein the least one second insulative layer has a plurality of openings passing therethrough for exposing one part of the top surface of each conductive base. The light-emitting unit includes at least one light-emitting element passing one of the openings and disposed on one of the conductive bases, wherein the at least one light-emitting element is electrically connected between the at least two conductive bases. The package unit includes at least one package resin body disposed on the second insulative unit to cover the at least one light-emitting element.

Another embodiment of the instant disclosure provides an LED package structure, comprising: a conductive substrate unit, a first insulative unit, a second insulative unit, a light-emitting unit and a package unit. The conductive substrate unit including at least two conductive bases separated from each other by a predetermined distance and at least one heat-dissipating base disposed between the at least two conductive bases and separated from the at least two conductive bases by a predetermined distance, wherein at least two gaps are respectively formed between one of the at least two conductive bases and the heat-dissipating base and between the other conductive base and the heat-dissipating base. The first insulative unit includes at least two first insulative layers respectively filled in the two gaps to join the heat-dissipating base with the at least two conductive bases. The second insulative unit includes at least one second insulative layer disposed on the conductive substrate unit, wherein the least one second insulative layer has a plurality of openings passing therethrough for exposing one part of the top surface of each conductive base and one part of the top surface of the heat-dissipating base. The light-emitting unit includes at least one light-emitting element passing one of the openings and disposed on the heat-dissipating base, wherein the at least one light-emitting element is electrically connected between the at least two conductive bases. The package unit includes at least one package resin body disposed on the second insulative unit to cover the at least one light-emitting element.

Therefore, the at least two conductive bases can be jointed with each other by the at least one first insulative layer formed between the at least two conductive bases, and the top surface of the at least one first insulative layer is flush with the top surface of each conductive bases, thus the top mold having a plurality of concave spaces can be used to form a plurality of package resin bodies to respective cover a plurality of light-emitting elements at the same time for achieving mass production. In addition, each light-emitting element can be positioned on one of the at least two conductive bases to increase heat-dissipating efficiency.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An LED package structure, comprising:
a conductive substrate unit including at least two conductive bases separated from each other by a predetermined distance, wherein at least one gap is formed between the at least two conductive bases;
a first insulative unit including at least one first insulative layer filled in the gap to join the at least two conductive bases;
a second insulative unit including at least one second insulative layer disposed on the conductive substrate unit, wherein the least one second insulative layer has a plurality of openings passing therethrough for exposing one part of the top surface of each conductive base;
a light-emitting unit including at least one light-emitting element passing one of the openings and disposed on one of the conductive bases, wherein the at least one light-emitting element is electrically connected between the at least two conductive bases; and
a package unit including at least one package resin body disposed on the second insulative unit to cover the at least one light-emitting element.

2. The LED package structure of claim 1, wherein one of the at least two conductive bases has a bottom concave portion formed on the bottom side thereof to communicate with the gap, and the at least one first insulative layer is filled in the bottom concave portion.

3. The LED package structure of claim 1, wherein each conductive base has a bottom concave portion formed on the bottom side thereof to communicate with the gap, and the at least one first insulative layer is filled in the bottom concave portion of each conductive base.

4. The LED package structure of claim 1, wherein one of the at least two conductive bases has a lateral concave portion formed on the lateral side thereof to communicate with the gap, and the at least one first insulative layer is filled in the lateral concave portion.

5. The LED package structure of claim 1, wherein each conductive base has a lateral concave portion formed on the lateral side thereof to communicate with the gap, and the at least one first insulative layer is filled in the lateral concave portion of each conductive base.

6. The LED package structure of claim 1, wherein the top surface and the bottom surface of the at least one first insulative layer are respectively flushed with the top surface and the bottom surface of each conductive base.

7. The LED package structure of claim 1, wherein one of the conductive bases includes a plurality of position grooves disposed on the top surface thereof to surround the at least one light-emitting element.

8. The LED package structure of claim 7, wherein the position grooves and the at least one light-emitting element are exposed by the same opening.

9. The LED package structure of claim 1, wherein the at least one package resin body includes a bottom resin portion disposed on the second insulative unit and a lens resin portion disposed above the at least one light-emitting element and integrally formed with the bottom resin portion.

10. The LED package structure of claim 1, further comprising: a surge-proof unit including at least one surge-proof element passing through one of the openings and disposed on one of the conductive bases, wherein the surge-proof element is electrically connected between the at least two conductive bases.

11. An LED package structure, comprising:
a conductive substrate unit including at least two conductive bases separated from each other by a predetermined distance and at least one heat-dissipating base disposed between the at least two conductive bases and separated from the at least two conductive bases by a predetermined distance, wherein at least two gaps are respectively formed between one of the at least two conductive bases and the heat-dissipating base and between the other conductive base and the heat-dissipating base;
a first insulative unit including at least two first insulative layers respectively filled in the two gaps to join the heat-dissipating base with the at least two conductive bases;
a second insulative unit including at least one second insulative layer disposed on the conductive substrate unit, wherein the least one second insulative layer has a plurality of openings passing therethrough for exposing one part of the top surface of each conductive base and one part of the top surface of the heat-dissipating base;
a light-emitting unit including at least one light-emitting element passing one of the openings and disposed on the heat-dissipating base, wherein the at least one light-emitting element is electrically connected between the at least two conductive bases; and
a package unit including at least one package resin body disposed on the second insulative unit to cover the at least one light-emitting element.

12. The LED package structure of claim 11, wherein each conductive base has a bottom concave portion formed on the bottom side thereof to communicate with each gap, and each first insulative layer is filled in the bottom concave portion of each conductive base.

13. The LED package structure of claim 11, wherein each conductive base has a lateral concave portion formed on the lateral side thereof to communicate with each gap, and each first insulative layer is filled in the lateral concave portion of each conductive base.

14. The LED package structure of claim 11, wherein the heat-dissipating base has two bottom concave portions formed on the bottom side thereof to respectively communicate with the two gaps, and each first insulative layer is filled in each bottom concave portion of the heat-dissipating base.

15. The LED package structure of claim 11, wherein the top surface of the at least one first insulative layer, the top surface of each conductive base and the top surface of the heat-dissipating base are coplanar, and the bottom surface of the at least one first insulative layer, the bottom surface of each conductive base and the bottom surface of the heat-dissipating base are coplanar.

16. The LED package structure of claim 11, wherein the heat-dissipating base includes a plurality of position grooves disposed on the top surface thereof to surround the at least one light-emitting element.

17. The LED package structure of claim 16, wherein the position grooves and the at least one light-emitting element are exposed by the same opening.

18. The LED package structure of claim 11, wherein the at least one light-emitting element is an LED chip.

19. The LED package structure of claim 11, wherein the at least one package resin body includes a bottom resin portion disposed on the second insulative unit and a lens resin portion disposed above the at least one light-emitting element and integrally formed with the bottom resin portion.

20. The LED package structure of claim 11, further comprising: a surge-proof unit including at least one surge-proof element passing through one of the openings and disposed on the heat-dissipating base, wherein the surge-proof element is electrically connected between the at least two conductive bases.
